(19) United States
(12) Patent Application Publication
(10) Pub. No.: US 2026/0277259 A1
(43) Pub. Date: Sep. 17, 2026

(54) Temperature Control Systems and Methods for a Material Handling Vehicle

(71) Applicant: The Raymond Corporation, Greene, NY (US)

(72) Inventors: Daniel B. Miller, Greene, NY (US); Andrew Fugh, Melrose, MA (US)

(21) Appl. No.: 19/562,582

(22) Filed: Mar. 10, 2026

Related U.S. Application Data
(60) Provisional application No. 63/772,222, filed on Mar. 14, 2025.

(51) Int. Cl. G05D 23/19; B66F 9/075; H05B 1/02

(52) U.S. Cl. CPC G05D 23/1951; B66F 9/0755; G05D 23/1931; H05B 1/0236

(57) ABSTRACT

A temperature control system and method for a material handling vehicle includes a housing, a heater disposed within the housing, a fan to direct air across the heater, a nozzle extending from the housing and configured to direct heated air from the fan over the surface of an object detection sensor positioned behind a bumper of the material handling vehicle, a temperature sensor, the temperature sensor to measure a temperature of the object detection sensor; and a controller. The controller activates the heater and the fan based on a temperature reading from the temperature sensor corresponding to the temperature of the object detection sensor.

### CROSS-REFERENCE TO RELATED APPLICATIONS

This application claims the benefit of U.S. Provisional Application No. 63/772,222 filed Mar. 14, 2025, which is hereby incorporated by reference in its entirety.

### BACKGROUND

Material handling vehicles may encounter a variety of different climates throughout daily use. For example, material handling vehicles may transfer between room temperature warehouses and cold-storage areas, which can create condensation or ice buildup on sensors and may lead to erroneous sensor readings.

### SUMMARY

According to one aspect of the present disclosure, a temperature control system for a material handling vehicle can be provided. The temperature control system can include a housing. A heater can be disposed within the housing. A fan can direct air across the heater. A nozzle can extend from the housing and can be configured to direct heated air from the heater over a surface of an object detection sensor positioned behind a bumper of the material handling vehicle. A temperature sensor can measure a temperature of the object detection sensor. And controller can activate the heater and the fan based on a temperature reading from the temperature sensor corresponding to the temperature of the object detection sensor.

In some examples, the heater can be in the form of a resistor.

In some examples, the temperature control system can include a temperature sensor. The temperature sensor can measure the temperature of the object detection sensor of the material handling vehicle.

In some examples, the controller can be configured to activate the heater and the fan when the temperature of the object detection sensor is below a predetermined lower threshold value.

In some examples, the controller can be configured to deactivate the heater and the fan when the temperature of the object detection sensor reaches a predetermined upper threshold value.

In some examples, the nozzle can include an angled surface at an outlet of the nozzle to direct the heated air towards the object detection sensor of the material handling vehicle.

In some examples, the object detection sensor of the material handling vehicle can be aligned with a horizontal opening defined by a bumper of the material handling vehicle.

According to another aspect of the present disclosure, a method of controlling a temperature of an object detection sensor positioned behind a bumper of a material handling vehicle can be provided. The method can include monitoring a temperature of the object detection sensor using a temperature sensor positioned adjacent to the object detection sensor. The method can include determining whether the monitored temperature of the object detection sensor is below a predetermined lower threshold. The method can include, in response to determining that the temperature of the object detection sensor is below the predetermined lower threshold, activating a temperature control system to heat the object detection sensor.

In some examples, the method can include determining whether the monitored temperature of the object detection sensor has reached a predetermined upper threshold. The method can include, in response to determining that the monitored temperature of the object detection sensor has reached the predetermined upper threshold, deactivating the temperature control system.

In some examples, the temperature control system can include a housing. A heater can be disposed within the housing. A fan can direct air across the heater. A nozzle can extend from the housing and can be configured to direct heated air from the fan over a surface of an object detection sensor of the material handling vehicle. A controller can activate the heater and the fan based on a temperature of the object detection sensor of the material handling vehicle.

In some examples, the heater can be in the form of a resistor.

In some examples, the nozzle can include an angled surface at an outlet of the nozzle to direct the heated air towards the object detection sensor of the material handling vehicle.

In some examples, the method can include monitoring an ambient temperature using a second temperature sensor positioned on an exterior of a bumper of the material handling vehicle. The method can include determining whether the material handling vehicle is operating in a cold environment based on the ambient temperature.

In some examples, the method can include capturing heated air within a recessed area behind a bumper of the material handling vehicle. The method can include recirculating the heated air via the temperature control system to heat the object detection sensor.

According to yet another aspect of the present disclosure, a temperature control system for a material handling vehicle can be provided. The temperature control system can include a housing. A heater can be disposed within the housing. A fan can be secured to the housing and can be configured to direct air across the heater. A nozzle can extend from the housing. The nozzle can include a mounting flange and a curved body extending from the mounting flange. The nozzle can be configured to direct heated air from the heater over a surface of an object detection sensor of the material handling vehicle. A first temperature sensor can be positioned on the surface of the object detection sensor of the material handling vehicle. A controller can be configured to activate the heater and the fan based on a temperature of the object detection sensor of the material handling vehicle as measured by the first temperature sensor. The object detection sensor can be positioned within a recessed area behind a bumper of the material handling vehicle, the bumper including a first portion and a second portion separated by a slot forming a horizontal opening, and wherein the object detection sensor is aligned with the slot.

In some examples, the controller can be configured to transfer to monitoring a second temperature sensor upon losing connection to the first temperature sensor or detecting an out-of-range reading from the first temperature sensor.

In some examples, the nozzle can include an angled surface at an outlet of the curved body. The angled surface can be oriented at an angle between approximately 30 degrees and approximately 60 degrees relative to a longitudinal axis of the nozzle to direct the heated air towards the object detection sensor of the material handling vehicle.

The bumper can include a first portion and a second portion separated by a slot forming a horizontal opening. The object detection sensor can be aligned with the slot.

In some examples, the controller can be configured to activate the heater and the fan when the temperature of the object detection sensor is below a predetermined lower threshold value. The controller can be configured to deactivate the heater and the fan when the temperature of the object detection sensor reaches a predetermined upper threshold value.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an axonometric view of a material handling vehicle including a temperature control system according to aspects of the present disclosure.

FIG. 2 is an axonometric view of the temperature control system of the material handling vehicle FIG. 1, with a bumper of the material handling vehicle rendered transparent.

FIG. 3 is an axonometric partial view of the material handling vehicle including the temperature control system of FIG. 1, with components of the material handling vehicle hidden for ease of illustration.

FIG. 4 is an axonometric view of the temperature control system of the material handling vehicle of FIG. 1.

FIG. 5 is a cross-sectional view of a nozzle of the temperature control system of FIG.

FIG. 6 is a detail axonometric view of the temperature control system of FIG. 4 installed within the material handling vehicle of FIG. 1, with the bumper of the material handling vehicle rendered transparent.

FIG. 7 is a bottom view of the temperature control system of FIG. 4 installed in the material handling vehicle of FIG. 1.

FIG. 8 is a graphical representation of the function of the temperature control system the material handling vehicle of FIG. 1.

FIG. 9 is an axonometric view of another example of a temperature control system according to aspects of the present disclosure.

FIG. 10 is a front view of the temperature control system of FIG. 9.

FIG. 11 is a diagrammatic representation of the function of the temperature control system of FIG. 9.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

It is also to be appreciated that material handling vehicles are designed in a variety of classes and configurations to perform a variety of tasks. It will be apparent to those of skill in the art that the present disclosure is not limited to any specific material handling vehicle, and can also be provided with various other types of material handling vehicle classes and configurations, including for example, lift trucks, forklift trucks, reach trucks, SWING REACH® vehicles, turret trucks, side loader trucks, counterbalanced lift trucks, pallet stacker trucks, order pickers, transtackers, tow tractors, and man-up trucks, and can be commonly found in warehouses, factories, shipping yards, and, generally, wherever pallets, large packages, or loads of goods can be required to be transported from place to place. The various systems and methods disclosed herein are suitable for any of operator controlled, pedestrian controlled, remotely controlled, and autonomously controlled material handling vehicles. Further, the present disclosure is not limited to material handling vehicles applications. Rather, the present disclosure may be provided for other types of vehicles, such as automobiles, buses, trains, tractor-trailers, farm vehicles, factory vehicles, and the like.

It should be noted that the various material handling vehicles listed above may perform a variety of load handling functions. For example, the material handling vehicles and/or the load handling portion (e.g., forks, mast, and/or fork carriage, etc.) of the material handling vehicles may be operated to move the forks up and down, tilt, reach (e.g., move the forks in and out), rotate, travel (e.g., move the material handling vehicle), and/or any combination thereof to complete a load handling function.

As should be noted, for certain types of vehicles there are training requirements imposed by various government agencies, laws, rules and regulations. For example, OSHA imposes a duty on employers to train and supervise operators of various types of material handling vehicles. Recertification every three years is also required. In certain instances, refresher training in relevant topics shall be provided to the operator when required. In all instances, the operator remains in control of the material handling vehicle during performance of any actions. Further, a warehouse manager remains in control of the fleet of material handling vehicles within the warehouse environment. The training of operators and supervision to be provided by warehouse managers requires among other things proper operational practices including among other things that an operator remain in control of the material handling vehicle, pay attention to the operating environment, and always look in the direction of travel.

In some examples, a material handling vehicle may include a temperature control system, which may be used to control a temperature (e.g., a surface temperature) of an object detection sensor. In some examples, a portion of the temperature control system may be positioned behind a bumper of the material handing vehicle (e.g., a split bumper defining a horizontal opening).

In some examples, the temperature control system may include a housing, which may contain one or more resistors, a fan, a nozzle, and one or more temperature sensors. In some examples, temperature sensors may be in communication with a controller (e.g., a microcontroller on a circuit board). The controller may be configured to activate the resistors or fans based on a temperature reading of the temperature sensor, which may correspond to a temperature of the object detection sensor. For example, the controller may be configured to activate the heaters and the fans if the temperature sensed by the temperature sensor is below a predetermined lower threshold value.

In some examples, the resistors may be held with the housing (e.g., a sealed housing), with the fan configured to direct air across the resistors to direct heated air through the nozzle, which may be directed at a surface of the object detection sensor. In some examples, after the heated air has been blown over the surface of the object detection sensor, the heated air may be trapped partially within the bumper such that the heated air may be recirculated to improve overall heating efficiency.

In some examples, the controller may power the heaters or fans via power from the battery of the vehicle, which the controller steps down (e.g., controls the reduction of a voltage) to power the heaters or fans. The controller may be further configured to prevent overheating of the object detection sensor. For example, the controller may automatically shut off the heaters if the temperature sensed by the temperature sensor (e.g., corresponding to a temperature of the object detection sensor) reaches a predetermined upper threshold value.

In some examples, the controller may monitor the temperature of the surface of the object detection sensor (e.g., via the temperature sensor) with respect to a lower temperature bound Tmin and an upper temperature bound Tmax. In one example, when the temperature reading drops below Tmin, the controller sends power to the blower fan and heaters and continues to send power until the reading surpasses Tmin and reaches Tmax. Following this, the controller may stop powering the blower fan and the heaters until the temperature reading drops below Tmin. In one particular example, Tmin may be set to 50 F and Tmax may be set to 70 F.

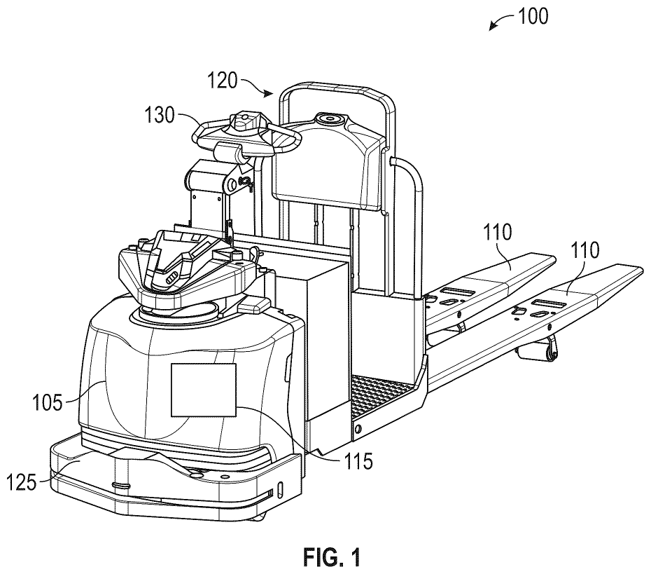

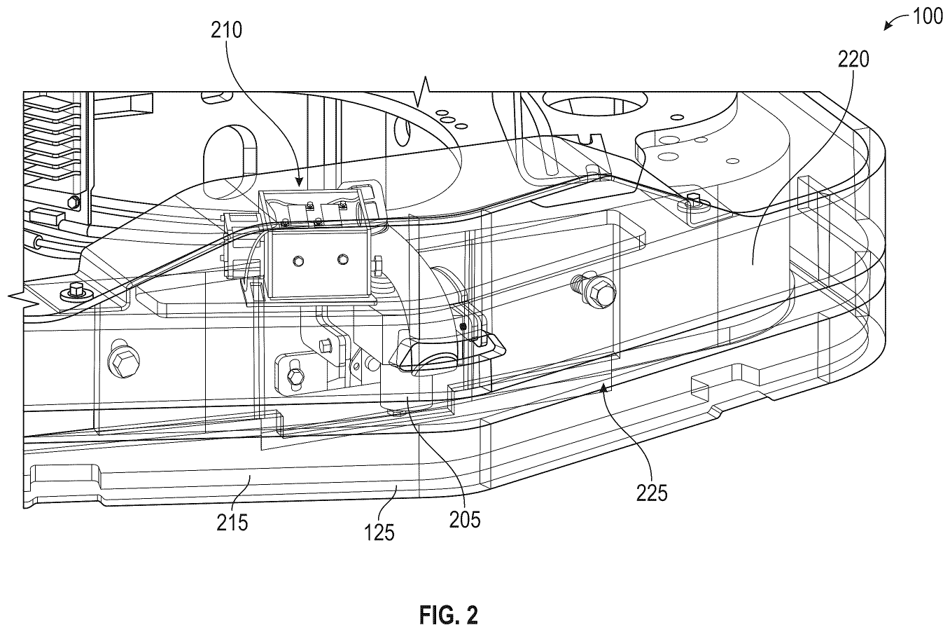

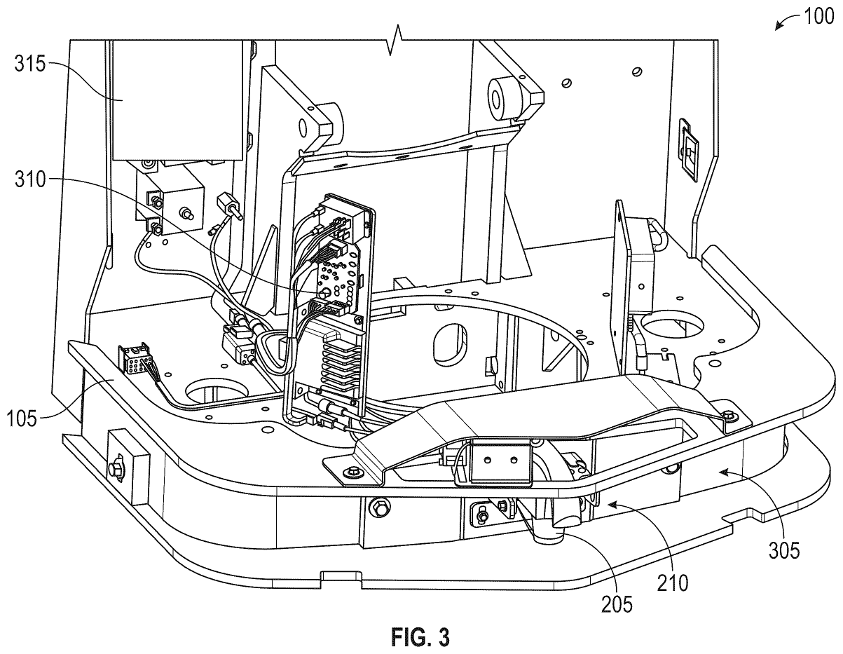

FIGS. 1-3 show an example of a material handling vehicle 100, which may include a body 105 having one or more forks 110 extending away from a first end of the body 105. Further, the material handling vehicle 100 may include an operator compartment 120 between the forks 110 and the body 105. In some examples, the forks 110 may be configured to carry or support a load (e.g., a pallet, barrel, etc.). Correspondingly, the operator compartment 120 may be configured to carry or support an operator during operation of the material handling vehicle 100. However, in other examples, the material handling vehicle 100 may not include the operator compartment 120 and the operator may instead stand on the floor or ground during operation of the material handling vehicle 100.

In some examples, to permit an operator to operate (e.g., steer, accelerate, decelerate, stop, etc.) the material handling vehicle 100, the material handling vehicle 100 may include a power source 115 (e.g., a battery, motor, engine, etc.) and a control arm 130. The control arm 130 may be rotatable or pivotable through a predetermined range to control steering (i.e., movement direction) or braking of the material handling vehicle 100. For example, the operator may move the control arm 130 vertically (e.g., up, and down) to control braking or enable a movement operation of the material handling vehicle 100. Correspondingly, the operator may move the control arm 130 laterally (e.g., side to side) to control a steering direction of a steer wheel of the material handling vehicle 100.

In some examples, in order to assist in object detection, maneuverability, or other functions of the material handling vehicle 100, the material handling vehicle 100 may include one or more sensors 205 (e.g., an object detection sensor, proximity sensor, vision sensor, LIDAR, radar, ultrasonic sensor, etc.) arranged within a bumper 125 of the material handling vehicle. For example, the bumper 125 may include a first portion 215 and a second portion 220, which may be separated by a horizontal opening (e.g., a slot 225). In some examples, the object detection sensor 205 may be aligned with the slot 225 (e.g., to permit the object detection sensor 205 to detect objects or other items outside of the material handling vehicle 100).

In some examples, during daily use, the material handling vehicle 100 may travel through a variety of climates or temperatures, which due to the variability in temperatures (e.g., from cold to ambient, etc.) may cause condensation or frost buildup on the object detection sensor 205, which may hinder the object detection sensor's operation. To mitigate the possibility of frost or condensation build up on the object detection sensor 205, the material handling vehicle 100 may include a temperature control system 210, which may be configured to control the temperature (e.g., surface temperature) of an object detection sensor 205. For example, the temperature control system 210 may be configured to maintain the object detection sensor 205 between predetermined temperature bounds (e.g., upper, and lower bounds) to prevent the object detection sensor 205 from icing up or generating condensation when moving between cold environments and ambient temperature environments.

In some examples, the temperature control system 210 and the object detection sensor 205 may be arranged within a recessed area 305 behind the bumper 125, which may further permit both heating and venting of the object detection sensor (e.g., via the slot 225) In some examples, heated air may be captured within the recessed area 305 and recirculated via the temperature control system 210 to permit efficient heating of the object detection sensor 205.

In some examples, in order to control the temperature control system 210, the temperature control system 210 may be connected to a controller 310 (e.g., including one or more processors and a memory). The controller 310 is configured to activate one or more heaters (e.g., resistors) or fans of the temperature control system 210 based on a temperature of the object detection sensor 205. For example, the controller 310 may be configured to activate the heaters, fans, etc. of the temperature control system 210 if the temperature of the object detection sensor 205 is below a predetermined value. In some examples, the controller 310 may power the heaters or fans via power from a battery 315 of the material handling vehicle 100, which the controller 310 steps down to power the heaters or fans of the temperature control system 210. In other examples, the controller 310 may power the heaters or fans via a separate power supply.

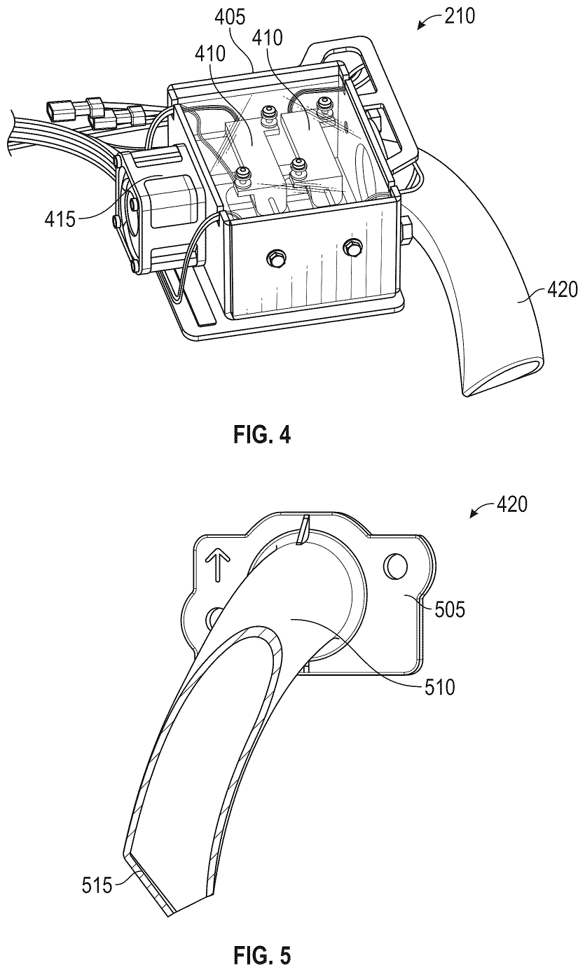

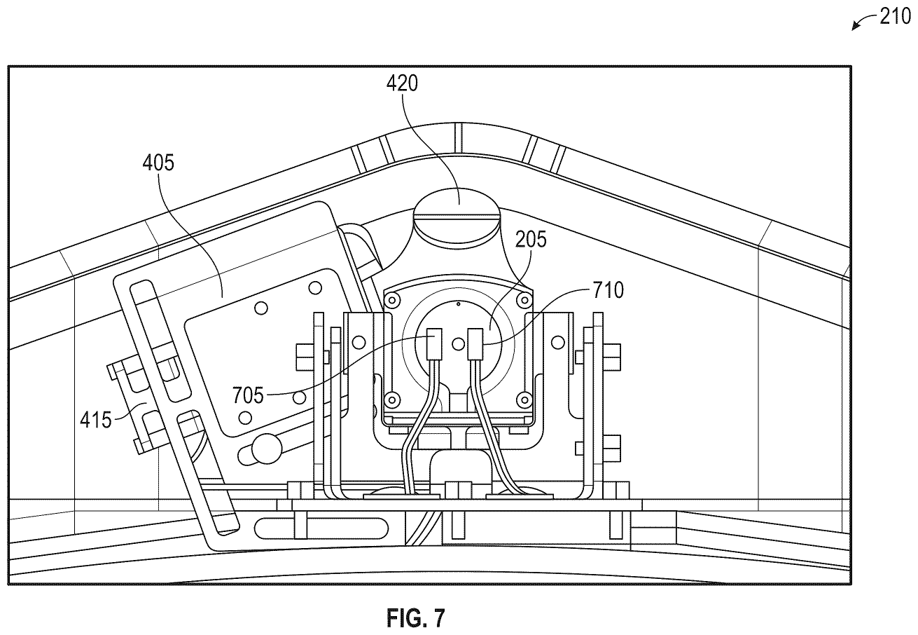

Turning to FIGS. 4-7, the temperature control system 210 may include a housing 405, which may include one or more heaters 410 (e.g., resistors, ceramic heating elements, infrared lamps, positive temperature coefficient (PTC) heaters, wire-wound resistors, thick film resistors, etc.) secured within the housing 405. The housing 405 may be constructed from materials with specific thermal properties to enhance heat distribution or insulation, such as metals with high thermal conductivity (e.g., aluminum, copper) for efficient heat transfer, or thermally insulative materials (e.g., high-temperature plastics, fiberglass composites) to contain heat within designated areas. In some examples, the housing 405 may be a sealed housing to prevent moisture ingress and protect internal components from environmental contaminants. In some examples, in order to thermally insulate the housing 405 and prevent heat loss through mounting points, the resistors may be secured to the housing 405 with one or more polymer (or other insulative) washers arranged between the housing 405 and the resistors. The insulative washers may be constructed from materials such as nylon, PTFE, silicone, or other high-temperature resistant polymers that maintain their insulative properties under elevated temperatures. In some examples, the heaters 410 may be configured to give off heat in response to an increase in current (e.g., from the battery 315), which can trap the heat within the housing 405. The heaters 410 may be electrically connected in series, parallel, or a combination thereof to achieve desired heating characteristics and power consumption levels.

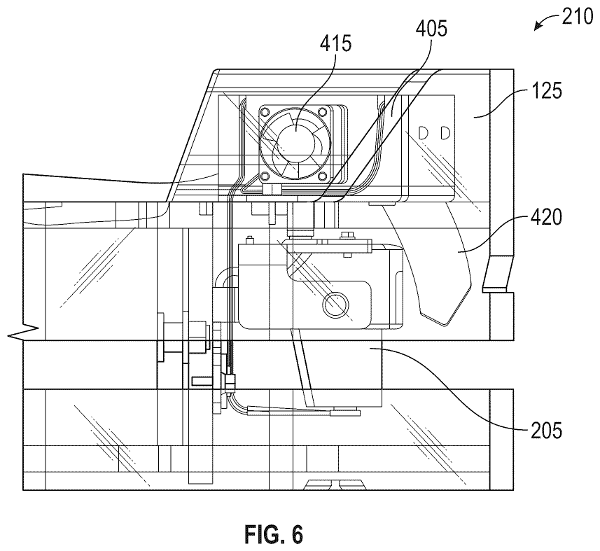

In some examples, in order to direct heat from within the housing 405 to the object detection sensor 205, the system 210 may include one or more fans 415 secured to the housing 405. The fans 415 may be axial fans, centrifugal blowers, or other air-moving devices configured to generate sufficient airflow to transport heated air from the heaters 410 through the system 210 and onto the object detection sensor 205. In some examples, the fans 415 may be variable speed fans that can be controlled by the controller 310 to adjust airflow rates based on heating requirements or ambient conditions. In some examples, the fans 415 may further be used to cool the object detection sensor 205 to prevent the object detection sensor 205 from overheating, such as by operating the fans 415 without activating the heaters 410 to provide convective cooling. In some examples, in order to guide heated air from within the housing 405 to the object detection sensor 205, the system 210 may include a nozzle 420, which may direct heated air onto the object detection sensor 205. The nozzle 420 may be configured to concentrate and focus the heated airflow onto specific areas of the object detection sensor 205, such as a lens surface or detection window, to maximize heating efficiency. In some examples, the nozzle 420 may include a mounting flange 505 (e.g., to permit mounting the nozzle 420 to the housing 405) and a curved body 510 extending from the flange 505. The mounting flange 505 may include mounting holes, clips, or other fastening features to securely attach the nozzle 420 to the housing 405. The curved body 510 may define an internal passage that transitions from a first cross-sectional shape at the mounting flange 505 to a second cross-sectional shape at an outlet end, thereby directing and shaping the airflow as it exits the nozzle 420. In some examples, in order to direct heat back towards the object detection sensor 205 (see, e.g., FIG. 6), an end of the nozzle 420 may include an angled surface 515.

The angled surface 515 may be configured at a predetermined angle relative to the longitudinal axis of the nozzle 420 to orient the heated airflow at an appropriate angle for effective heating of the object detection sensor 205 surface. In some examples, the angled surface 515 may be oriented at an angle between approximately 30 degrees and approximately 60 degrees relative to the longitudinal axis of the nozzle 420. In one particular example, the angled surface 515 may be oriented at approximately 45 degrees relative to the longitudinal axis of the nozzle 420. The specific angle may be selected based on the relative positioning of the nozzle 420 and the object detection sensor 205, the distance between the nozzle outlet and the object detection sensor 205 surface, and the desired airflow coverage area on the object detection sensor 205. In some examples, the angled surface 515 may create a beveled edge at the nozzle outlet that directs the heated air downward or laterally toward the object detection sensor 205. The beveled edge may be formed by cutting or molding the nozzle 420 at the predetermined angle, creating an elliptical or elongated outlet opening that spreads the heated airflow across a larger surface area of the object detection sensor 205. In some examples, the angled surface 515 may include a smooth, continuous surface to minimize turbulence and maintain laminar airflow as the heated air exits the nozzle 420. In other examples, the angled surface 515 may include surface features such as ridges, channels, or vanes to further direct or distribute the heated airflow across the object detection sensor 205 surface. The configuration of the angled surface 515 may be optimized to ensure uniform heating across the entire detection surface of the object detection sensor 205, thereby preventing localized condensation or frost formation that could impair sensor performance.

In some examples, to facilitate temperature monitoring of the object detection sensor 205, the system 210 may include one or more temperature sensors arranged on or near the exterior surface of the object detection sensor 205. The temperature sensors may be thermistors, thermocouples, resistance temperature detectors (RTDs), infrared temperature sensors, or other temperature sensing devices capable of measuring the surface temperature of the object detection sensor 205 with sufficient accuracy and response time. For example, the system 210 may include two temperature sensors (e.g., a first temperature sensor 705 and a second temperature sensor 710), which may both be positioned directly on the surface of the object detection sensor 205. The temperature sensors may be affixed to the object detection sensor 205 using thermally conductive adhesive, mechanical fasteners, or other attachment methods that ensure good thermal contact between the temperature sensors and the object detection sensor 205 surface. However, in some examples, only one of the temperature sensors (e.g., the first sensor 705) may be monitored by the controller 310 during normal operation, while the other temperature sensor (e.g., the second sensor 710) may be used for redundancy purposes to ensure continued operation in the event of a temperature sensor failure. For example, in operation, upon losing connection to the first sensor 705 or detecting an out-of-range reading from the first sensor 705, the controller 310 may transfer to monitoring the second sensor 710, and send an alert to the vehicle (e.g., via the CAN bus on the vehicle) to notify an operator or maintenance personnel of the temperature sensor failure. In another example, the system 210 may utilize two temperature sensors with different functions, with one temperature sensor positioned on or near an exterior of the bumper 125 to measure ambient temperature and a second temperature sensor positioned on or near the object detection sensor 205 to measure sensor temperature. This configuration may allow the controller 310 to determine whether the material handling vehicle 100 is operating in a cold environment based on the ambient temperature reading, and to adjust the heating control strategy accordingly based on both the ambient temperature and the object detection sensor 205 surface temperature.

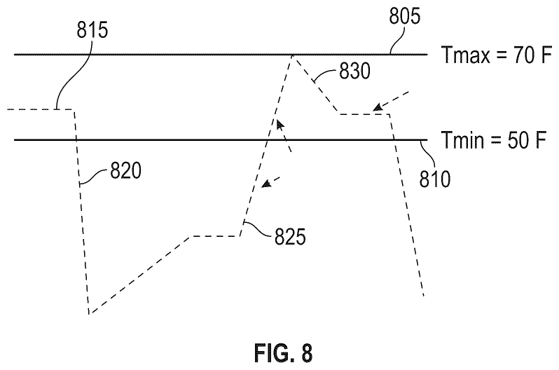

FIG. 8 shows a graphical illustration of the temperature control system 210 in use. For example, as the material handling vehicle 100 is traversing throughout a warehouse or other work environment, the controller 310 monitors the temperature of the object detection sensor 205 (e.g., via the first or second temperature sensors 705, 710). When the temperature is between an upper temperature bound Tmax 805 and a lower temperature bound Tmin 810 (e.g., as shown in region 815), the controller may not power the fan 415 or the heaters 410.

However, when the temperature reading drops below Tmin (e.g., as shown in region 820), the controller 310 sends power to the fan 415 and heaters 410, which heats the object detection sensor 205 (e.g., as shown in region 825). In some examples, the controller 310 may continue to power the fan 415 and heaters 410 until the temperature reading reaches Tmax. Correspondingly, once the temperature reading reaches Tmax, the controller 310 may stop powering the fan 415 and the heaters 410 (e.g., as shown in region 830) until the temperature drops below Tmin.

In one example, Tmin may be set to 50 degrees Fahrenheit and Tmax may be set to 70 degrees Fahrenheit. However, in other examples, Tmin may be set to greater or less than 50 degrees (e.g., 40 degrees, 60 degrees, etc.), while Tmax may be set to greater than 70 degrees (e.g., 90 degrees, 110 degrees, etc.). Further, the temperature differential between Tmin and Tmax may be designed so that temperature swings of the system turning on and off does not immediately cross the other bound, which could lead to rapid power cycling in the blower, which may reduce the longevity of the system.

In some examples, the sensors, heaters, fans, etc. could all be located in areas other than the bumper 125 (e.g., within the body 105, etc.). In other examples, the system 210 may include additional fans 415, which may use forced convection to direct heat from the heaters 410 to the object detection sensor 205 or be used to cool the object detection sensor to prevent overheating of a power supply. Depending on the number of heaters used, active cooling may be utilized. For example, if more than two (2) resistors are used that draw power from a power supply, a vent hole and/or fan may be added to the system in order to cool the power supply.

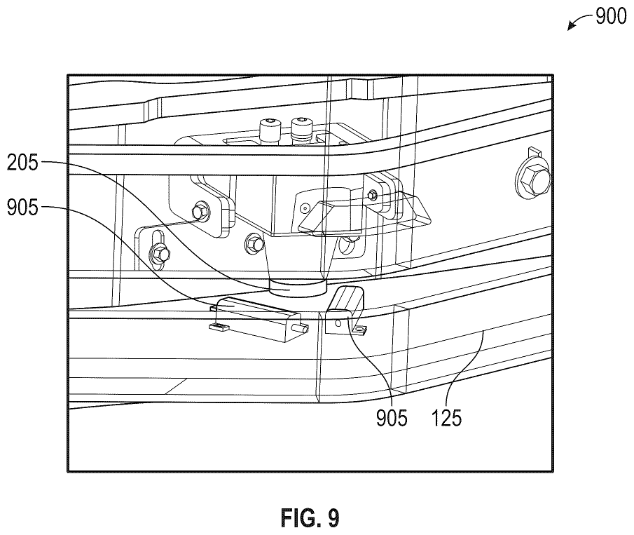

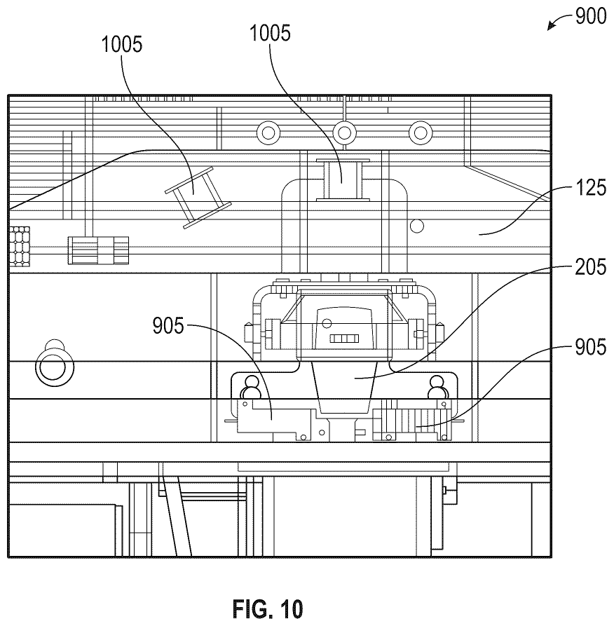

FIGS. 9-11 illustrate another example of a temperature control system 900. As will be recognized, the temperature control system 900 shares a number of components in common with and operates in a similar fashion to the examples illustrated and described previously (e.g., the temperature control system 210). For the sake of brevity, these common features will not be again described below in detail. Rather, previous discussion of commonly named or numbered features, unless otherwise indicated, also applies to example configurations of the temperature control system 900.

In some examples, the temperature control system 900 may include one or more resistors 905, which may be positioned beneath the object detection sensor 205. Correspondingly, as the resistors 905 are powered via the controller 310, the resistors may give off heat, which rises to heat the object detection sensor 205. Further, the heat from the resistors 905 may be captured within the recessed area of the bumper 125. In some examples, one or more fans 1005 may be used to cool the object detection sensor 205 (e.g., in the event the object detection sensor gets too hot).

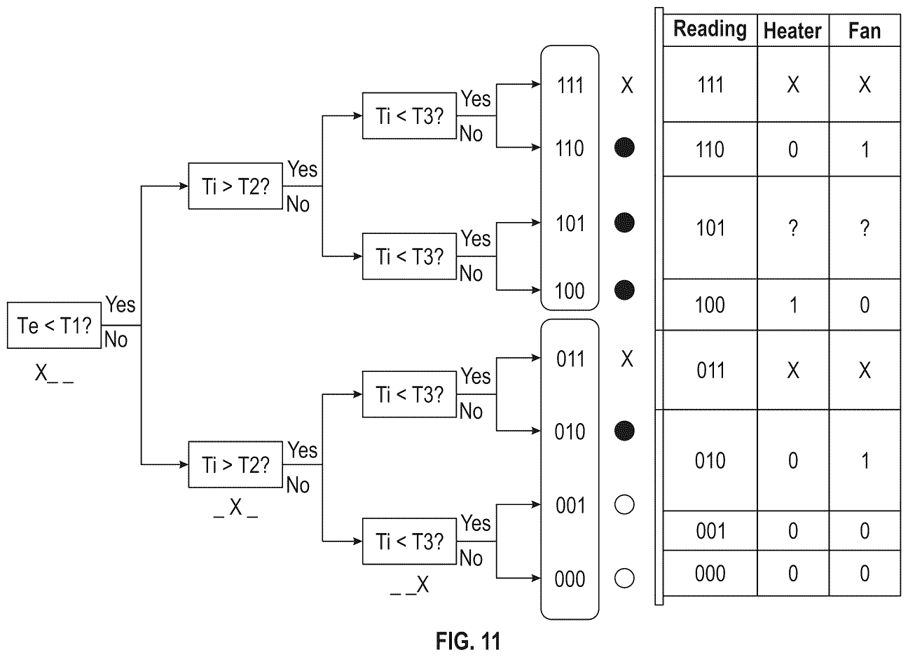

In some examples, the temperature control system 900 may include a first temperature sensor, which may monitor a temperature of the object detection sensor 205 and a second temperature sensor, which may monitor an ambient temperature of the area around the material handling vehicle 100. In one example use of the temperature control system 900 (see, e.g., FIG. 11), the system first determines if the ambient temperature (Te), monitored by the second temperature sensor, is less than or greater than a predetermined temperature (T1, e.g., 45 F). If the Te is less than T1 the system determines that the material handling vehicle is in a cold environment. If the Te is greater than T1 the system determines that the material handling vehicle is not in a cold environment. Regardless of whether the vehicle is in a cold environment or not, the system next determines if the surface temperature of the object detection sensor (Ti), monitored by the first temperature sensor, is greater than a predetermined temperature (T2, e.g., 122 F). In some examples, the system then determines if Ti is less than a predetermined temperature (T3, e.g., 100 F).

In the cold environment, if Ti is greater than T2 and Ti is greater than T3 the object detection sensor may overheat and the controller 310 may activate the fan to cool down the object detection sensor. If Ti is less than T2 and Ti is less than T3 the system would need to refer to a previous state to determine the course of action required. In other words, if the system was previously heating, the system will continue to heat. If the system was off when it enters this state, then the system remains off until a new reading is found. If Ti is greater than T2 and Ti is less than T3 then the system will send an indication to an operator to check the temperature (or other) sensors. If Ti is less than T2 and Ti is greater than T3 then the system activates the heating system. Based on the above control logic, the system determines whether to activate one or more heaters, one or more fans, or take no action.

Outside of a cold environment, if Ti is greater than T2 and Ti is greater than T3 the object detection sensor is too hot and actions can be taken to cool the object detection sensor, such as turning on a fan or turning off the heater. If Ti is less than T2 and Ti is less than T3 then the system is at an acceptable temperature and no action is taken. If Ti is less than T2 and Ti is greater than T3 then the system is at risk of overheating and should be monitored. Based on the above control logic, the system determines whether to activate one or more heaters, one or more fans, or take no action.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

### FURTHER EXAMPLES

Example 1. A temperature control system for a material handling vehicle, the temperature control system comprising: a housing; a heater disposed within the housing; a fan to direct air across the heater; a nozzle extending from the housing and configured to direct heated air from the fan over a surface of an object detection sensor of the material handling vehicle; and a controller, the controller to activate the heater and the fan based on a temperature of the object detection sensor of the material handling vehicle.

Example 2. The temperature control system of Example 1, wherein the heater is in the form of a resistor.

Example 3. The temperature control system of Example 1 or Example 2, further comprising: a temperature sensor, the temperature sensor to measure the temperature of the object detection sensor of the material handling vehicle.

Example 4. The temperature control system of any of Examples 1-3, wherein the controller is configured to activate the heater and the fan when the temperature of the object detection sensor is below a predetermined lower threshold value.

Example 5. The temperature control system of any of Examples 1-4, wherein the controller is configured to deactivate the heater and the fan when the temperature of the object detection sensor reaches a predetermined upper threshold value.

Example 6. The temperature control system of any of Examples 1-5, wherein the nozzle includes an angled surface at an outlet of the nozzle to direct the heated air towards the object detection sensor of the material handling vehicle.

Example 7. The temperature control system of any of Examples 1-6, wherein the object detection sensor of the material handling vehicle is aligned with a horizontal opening defined by a bumper of the material handling vehicle.

Example 8. A method of controlling a temperature of an object detection sensor in a material handling vehicle, the method comprising: monitoring a temperature of the object detection sensor using a temperature sensor positioned adjacent to the object detection sensor; determining whether the monitored temperature of the object detection sensor is below a predetermined lower threshold; in response to determining that the temperature of the object detection sensor is below the predetermined lower threshold, activating a temperature control system to heat the object detection sensor.

Example 9. The method of Example 8, further comprising: determining whether the monitored temperature of the object detection sensor has reached a predetermined upper threshold; and in response to determining that the monitored temperature of the object detection sensor has reached the predetermined upper threshold, deactivating the temperature control system.

Example 10. The method of Example 8 or Example 9, wherein the object detection sensor is positioned behind a bumper of the material handling vehicle.

Example 11. The method of any of Examples 8-10, wherein the temperature control system includes: a housing; a heater disposed within the housing; a fan to direct air across the heater; a nozzle extending from the housing and configured to direct heated air from the fan over a surface of an object detection sensor of the material handling vehicle; and a controller, the controller to activate the heater and the fan based on a temperature of the object detection sensor of the material handling vehicle.

Example 12. The method of any of Examples 8-11, wherein the heater is in the form of a resistor.

Example 13. The method of any of Examples 8-12, wherein the nozzle includes an angled surface at an outlet of the nozzle to direct the heated air towards the object detection sensor of the material handling vehicle.

Example 14. The method of any of Examples 8-13, further comprising: monitoring an ambient temperature using a second temperature sensor positioned on an exterior of a bumper of the material handling vehicle; and determining whether the material handling vehicle is operating in a cold environment based on the ambient temperature.

Example 15. The method of any of Examples 8-14, further comprising: capturing heated air within a recessed area behind a bumper of the material handling vehicle; and recirculating the heated air via the temperature control system to heat the object detection sensor.

Example 16. A temperature control system for a material handling vehicle, the temperature control system comprising: a housing; a heater disposed within the housing; a fan secured to the housing and configured to direct air across the heater; a nozzle extending from the housing, the nozzle including a mounting flange and a curved body extending from the mounting flange, the nozzle configured to direct heated air from the fan over a surface of an object detection sensor of the material handling vehicle; a first temperature sensor positioned on the surface of the object detection sensor of the material handling vehicle; a controller configured to activate the heater and the fan based on a temperature of the object detection sensor of the material handling vehicle as measured by the first temperature sensor.

Example 17. The temperature control system of Example 16, wherein the controller is configured to transfer to monitoring a second temperature sensor upon losing connection to the first temperature sensor or detecting an out-of-range reading from the first temperature sensor.

Example 18. The temperature control system of Example 16 or Example 17, wherein the nozzle includes an angled surface at an outlet of the curved body, the angled surface oriented at an angle between approximately 30 degrees and approximately 60 degrees relative to a longitudinal axis of the nozzle to direct the heated air towards the object detection sensor of the material handling vehicle.

Example 19. The temperature control system of any of Examples 16-18, wherein the object detection sensor of the material handling vehicle is positioned within a recessed area behind a bumper of the material handling vehicle, the bumper including a first portion and a second portion separated by a slot forming a horizontal opening, and wherein the object detection sensor is aligned with the slot.

Example 20. The temperature control system of any of Examples 16-19, wherein the controller is configured to: activate the heater and the fan when the temperature of the object detection sensor is below a predetermined lower threshold value; and deactivate the heater and the fan when the temperature of the object detection sensor reaches a predetermined upper threshold value.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of plus or minus 15 percent or less, inclusive of the endpoints of the range. Similarly, the term “substantially equal” (and the like) as used herein with respect to a reference value refers to variations from the reference value of less than plus or minus 30 percent, inclusive. Where specified, “substantially” can indicate in particular a variation in one numerical direction relative to a reference value. For example, “substantially less” than a reference value (and the like) indicates a value that is reduced from the reference value by 30 percent or more, and “substantially more” than a reference value (and the like) indicates a value that is increased from the reference value by 30 percent or more.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A temperature control system for a material handling vehicle, the temperature control system comprising:
a housing;
a heater disposed within the housing;
a fan to direct air across the heater;
a nozzle extending from the housing and configured to direct heated air from the heater over a surface of an object detection sensor positioned behind a bumper of the material handling vehicle;
a temperature sensor, the temperature sensor to measure a temperature of the object detection sensor; and
a controller, the controller to activate the heater and the fan based on a temperature reading from the temperature sensor corresponding to the temperature of the object detection sensor.

2. The temperature control system of claim 1, wherein the heater is in the form of a resistor.

3. The temperature control system of claim 1, wherein the sensor of the material handling vehicle is positioned within a recessed area behind the bumper of the material handling vehicle, the bumper including a first portion and a second portion separated by a slot forming a horizontal opening, and wherein the sensor is aligned with the slot.

4. The temperature control system of claim 3, wherein the controller is configured to activate the heater and the fan when the temperature of the object detection sensor is below a predetermined lower threshold value.

5. The temperature control system of claim 4, wherein the controller is configured to deactivate the heater and the fan when the temperature of the object detection sensor reaches a predetermined upper threshold value.

6. The temperature control system of claim 1, wherein the nozzle includes an angled surface at an outlet of the nozzle to direct the heated air towards the object detection sensor of the material handling vehicle.

7. The temperature control system of claim 1, wherein the object detection sensor of the material handling vehicle is aligned with a horizontal opening defined by the bumper of the material handling vehicle.

8. A method of controlling a temperature of an object detection sensor positioned behind a bumper of a material handling vehicle, the method comprising:
monitoring a temperature of the object detection sensor using a temperature sensor positioned adjacent to the object detection sensor;
determining whether the monitored temperature of the object detection sensor is below a predetermined lower threshold;
in response to determining that the temperature of the object detection sensor is below the predetermined lower threshold, activating a temperature control system to heat the object detection sensor.

9. The method of claim 8, further comprising:
determining whether the monitored temperature of the object detection sensor has reached a predetermined upper threshold; and
in response to determining that the monitored temperature of the object detection sensor has reached the predetermined upper threshold, deactivating the temperature control system.

10. The method of claim 8, wherein the object detection sensor of the material handling vehicle is positioned within a recessed area behind the bumper of the material handling vehicle, the bumper including a first portion and a second portion separated by a slot forming a horizontal opening, and wherein the sensor is aligned with the slot.

11. The method of claim 8, wherein the temperature control system includes:
a housing;
a heater disposed within the housing;
a fan to direct air across the heater;
a nozzle extending from the housing and configured to direct heated air from the heater over a surface of the object detection sensor of the material handling vehicle; and
a controller, the controller to activate the heater and the fan based on a temperature of the object detection sensor of the material handling vehicle.

12. The method of claim 11, wherein the heater is in the form of a resistor.

13. The method of claim 11, wherein the nozzle includes an angled surface at an outlet of the nozzle to direct the heated air towards the object detection sensor of the material handling vehicle.

14. The method of claim 8, further comprising:
monitoring an ambient temperature using a second temperature sensor positioned on an exterior of a bumper of the material handling vehicle; and
determining whether the material handling vehicle is operating in a cold environment based on the ambient temperature.

15. The method of claim 8, further comprising:
capturing heated air within the recessed area behind the bumper of the material handling vehicle; and
recirculating the heated air via the temperature control system to heat the object detection sensor.

16. A temperature control system for a material handling vehicle, the temperature control system comprising:
a housing;
a heater disposed within the housing;
a fan secured to the housing and configured to direct air across the heater;
a nozzle extending from the housing, the nozzle including a mounting flange and a curved body extending from the mounting flange, the nozzle configured to direct heated air from the heater over a surface of an object detection sensor of the material handling vehicle;
a first temperature sensor positioned on the surface of the object detection sensor of the material handling vehicle; and
a controller configured to activate the heater and the fan based on a temperature of the object detection sensor of the material handling vehicle as measured by the first temperature sensor;
wherein the object detection sensor is positioned within a recessed area behind a bumper of the material handling vehicle, the bumper including a first portion and a second portion separated by a slot forming a horizontal opening, and wherein the object detection sensor is aligned with the slot.

17. The temperature control system of claim 16, wherein the controller is configured to transfer to monitoring a second temperature sensor upon losing connection to the first temperature sensor or detecting an out-of-range reading from the first temperature sensor.

18. The temperature control system of claim 16, wherein the nozzle includes an angled surface at an outlet of the curved body, the angled surface oriented at an angle between approximately 30 degrees and approximately 60 degrees relative to a longitudinal axis of the nozzle to direct the heated air towards the object detection sensor of the material handling vehicle.

19. The temperature control system of claim 16, wherein the controller is configured to:
activate the heater and the fan when the temperature of the object detection sensor is below a predetermined lower threshold value; and
deactivate the heater and the fan when the temperature of the object detection sensor reaches a predetermined upper threshold value.
